(19) United States
(12) Patent Application Publication
(10) Pub. No.: US 2021/0192003 A1
(43) Pub. Date: Jun. 24, 2021

(54) UPLOADING AND ACCESSING CONTENT VIA PHYSICAL GRAPHICAL CODE

(71) Applicant: RedTelly Inc., Berkeley, CA (US)

(72) Inventor: Farzad Kargaran, Richmond, CA (US)

(21) Appl. No.: 17/129,625

(22) Filed: Dec. 21, 2020

Related U.S. Application Data
(60) Provisional application No. 62/952,151, filed on Dec. 20, 2019.

(51) Int. Cl. G06F 16/955; G06F 16/957; G06F 16/958

(52) U.S. Cl. CPC G06F 16/9554; G06F 16/986; G06F 16/9577

(57) ABSTRACT

A system and method for using a code that is associated with a physical object, where a first electronic device can read the code and access a platform to generate a media file associated with the code. In some implementations, the platform can be embedded in or on a webpage, and the application functionality can be provided by the application. The webpage or the application can also provide or host other functions, such as generating coupons or other digital offerings, configuring a view or background of an image or video file, link to social media websites or other informational or commercial websites, or the like. A subsequent read of the code provides access to the generated media file.

### CROSS-REFERENCES TO RELATED APPLICATIONS

This application claims the benefit of U.S. Provisional Application No. 62/952,151, filed Dec. 20, 2019, and entitled “UPLOADING AND ACCESSING CONTENT VIA PHYSICAL GRAPHICAL CODE,” the entirety of which is hereby incorporated by reference herein.

### TECHNICAL FIELD

The subject matter described herein relates to digital content creation, storage, and access, and more particularly to a system and method for using an encoded physical object, such as tags or graphical codes, to upload to and/or access and view content in a database hosted on a server.

### BACKGROUND

Sharing of digital content between a content creator and a content viewer is typically done via electronic means, such as by electronic mail (“e-mail”), electronic texts, or via a website. Such sharing necessarily requires an electronic communication channel directly between the content creator and the content viewer.

### SUMMARY

A system and method are described herein for using an encoded physical object or medium, such as Quick Response (QR) Codes that are printed on a physical medium such as a sticker, near-field communication (NFC) tags, radio frequency identifier (RFID) tags, or similar physical graphical codes, to upload to and/or access and view content in a database hosted on a server through a network. To access particular content or a particular content file, a user device can be used to scan or communicate with the encoded physical object.

The user device can be a smartphone and/or its camera, or a camera-controlling software module with embedded code-recognition software or other suitable input. In some implementations, a QR Code scanner on a smartphone decodes the QR Code into a URL and loads the decoded URL webpage in a browser executed by the smartphone. The remote server retrieves content corresponding to or associated with the QR Code, and presents the retrieved content to a user device preferably through the browser, or presents an upload page or other mechanism to the user device so the user can upload his/her content to the system.

In other implementations, a code can be implemented as a tag, such as a NFC tag or RFID tag, where the code can be read from the tag when a smartphone enabled with tag reading capabilities is positioned near the tag. Once the code is read, the smartphone can be configured to launch a media generation platform, which can include a media generation application, that enables a user to generate a media file, such as a video file, an audio file such as a voice message or chat, or other media file such as an augmented reality (AR) digital file. The media file is tagged with the code, and can then be transmitted for being uploaded to a server and associated database, where it is accessible by a different smartphone that reads the code from the tag.

In some aspects, a method reading, by a first smartphone, a code that is associated with a physical object. The code is configured to allow the first smartphone to launch a media generation application. The method further includes generating, by the first smartphone, a media file using the media generation application, and transmitting, by the first smartphone, the media file to a server via a network on a first communication channel for storing the media file in a database associated with the server. The storing includes storing the code associated with the physical object and associating the code with the media file. The method further includes enabling access from the database via the server to the media file by a second smartphone, the access being enabled on a second communication channel upon the second smartphone reading the code that is associated with the physical object.

In other aspects, a system includes a code that is associated with a physical object, the code being configured to be read by a first smartphone. The system further includes a media generation application configured to allow the first smartphone to generate a media file after reading the code, the media file being associated with the code, and a server that is configured to communicate with the first smartphone via a network for receiving the media file from the first smartphone. The system further includes a database associated with the server and configured to store the media file based on the code. The media file is accessible from the database and downloadable from the server via the network by a second smartphone that reads the code and transmits a request to the server for the media file. The request is associated with the second smartphone reading the code that is associated with the physical object, the media file being playable by the second smartphone after the media file is downloaded.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a system and method for using QR codes, or similar physical graphical codes, to upload to and/or access and view content in a database hosted on a server, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter;

FIG. 2A shows a process for generating a QR code that can be used for uploading and access of digital content, such as video;

FIG. 2B shows a process of scanning a QR code by which a user can access digital content from a remote server;

FIG. 3 shows a process flow diagram illustrating aspects of a method having one or more features consistent with implementations of the current subject matter; and

FIG. 4 shows a system illustrating aspects of an alternative system showing features consistent with implementations of the current subject matter.

When practical, similar reference numbers denote similar structures, features, or elements.

### DETAILED DESCRIPTION

This document describes a system and method for using a code that is associated with a physical object, where a first electronic device can read the code and access a platform to generate a media file associated with the code. The platform can include a software application. In some implementations, the platform can be embedded in or on a webpage, and the application functionality can be provided by the application. The webpage or the application can also provide or host other functions, such as generating coupons or other digital offerings, configuring a view or background of an image or video file, link to social media websites or other informational or commercial websites, or the like.

The first electronic device can employ native software and functionality to perform the read of the code, and which software and functionality may be integrated in a media generation application, or which may be embedded in a webpage, for example. The first electronic device can then upload and store the media file to a storage, such as a database in a cloud storage platform. The first electronic device can be a smartphone, having cellular or other communication capabilities, and accordingly hereafter the electronic devices are referred to simply as “smartphones.”

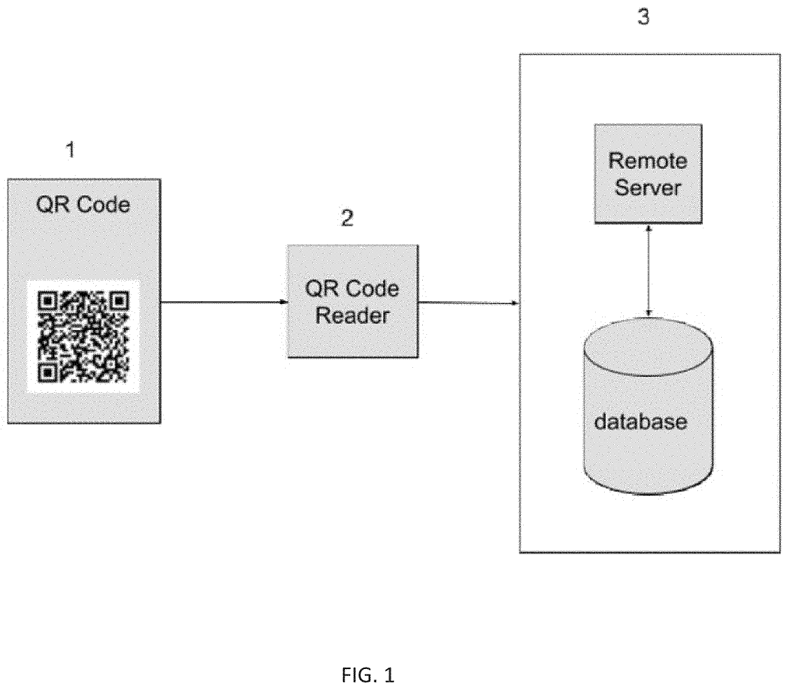

FIG. 1 illustrates a system and method for using a code, such as a Quick Response (QR) code 1, to upload to and/or access and view content in a database hosted on a server 3 through a network. The server can be a remote server, and/or part of a server cluster that forms a cloud server platform. To access a particular content, a user scans the QR code by using a QR code reader implemented by their user device, such as their smartphone camera or a camera-controlling software with embedded code-recognition software or other suitable input means. A QR code reader scans and decodes the QR code into a uniform resource locator (URL), which is an address of a webpage on the World Wide Web, and loads the decoded URL webpage in a browser or similar web-searching tool. The server 3 retrieves the content corresponding to or associated with the QR code from a database, and presents the retrieved content to a user device with the result through the browser, or presents an upload page to the user device so the user can upload his/her content to the system.

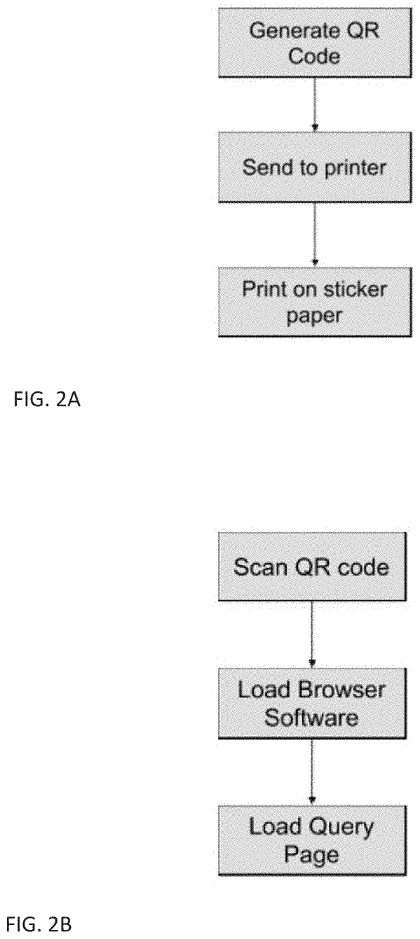

As shown in FIG. 2A, to generate each QR code, a string generator generates a random unique alphanumeric character string, and concatenates the generated string into a domain URL (such as, for example, www.redtelly.io/), which is the address of a target website. The string generator can be a software module, a hardware module, or combination thereof. The alphanumeric character string can include 22 characters. Alternatively, the character string can include less than 22 characters, or more than 22 characters. The result is a unique URL which is the online address to a folder in a database on a remote server. The software program then translates the generated URL into a QR code using a QR code generator by encoding the alphanumeric characters into sequence of black/white pixels in data region of QR code. The software program can then embed the encoded QR code into a file, such as, for example, a Portable Document Format (PDF) or other format configured to present documents, including text formatting, images and/or video, in a manner independent of application software, hardware, and operating systems.

The PDF files are then sent to a printer, where the printer can print them on sticker paper that contains one or more stickers. For example, the sticker paper can include multiple, i.e. 20 or more, individual stickers, each of which has a QR code printed or affixed thereon. Each of the stickers can then be applied on any hardcopy or physical objects including, but not limited to, greeting cards, gift cards, patient or medical records, student report cards, sports score cards, or other hardcopy printed materials, boxes, gifts, or any other physical object. Alternatively, instead of stickers, the QR code can be printed on a tag that can be attached, hung, affixed, snapped to, glued on, or otherwise associated with a physical object.

In accordance with some implementations, a user scans the QR code with a scanner device, such as a smartphone camera and camera-controlling software with embedded code-recognition software, for instance. The QR code can also be scanned by a software application (“app”) that either accesses the code-recognizing camera or has code-recognizing software of its own. The scanner can be optical, but may also be infrared, laser, or other type of scanner or imaging system.

However implemented, the QR code-recognizing software analyzes the image(s) captured by the camera. Binary data encoded by a sequence of black/white pixels in a data region of QR Code is decoded as a web URL containing alphanumeric characters. The QR code-recognizing software opens the URL webpage or presents to the user an option (notification, or popup tooltip) to open the URL in the default browser app of choice.

The user device receives user confirmation of the action, such as by an input into the user device, and the browser app is foregrounded. The browser address bar is automatically populated with the decoded URL, and the browser requests the ISP's DNS server to resolve the URL to an IP address. The browser makes an HTTP request to the IP address and the target website server at that IP returns the web page uniquely configured based on the hash value in the URL path. Web page configuration is described further below.

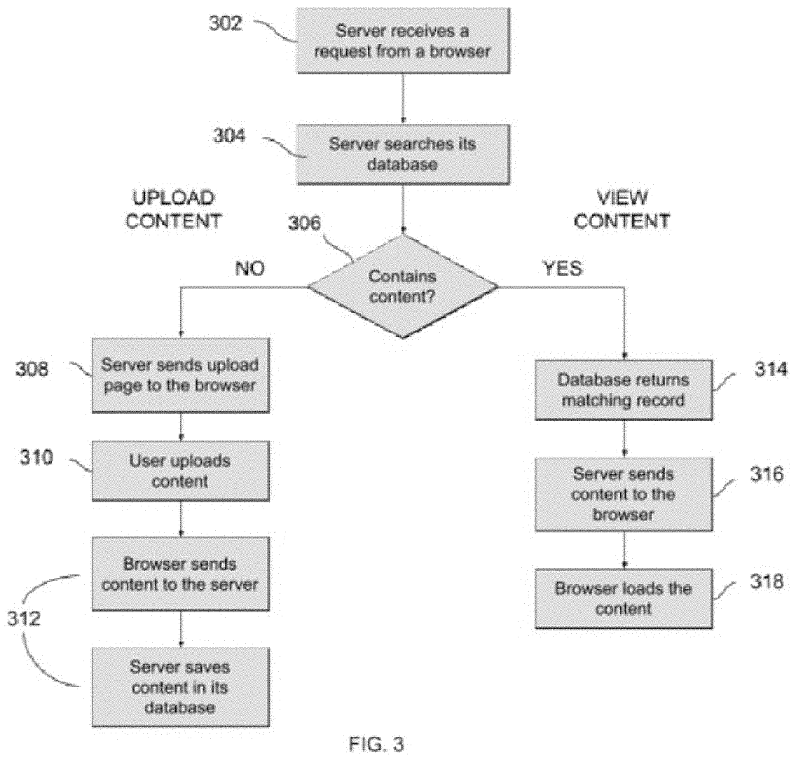

FIG. 3 illustrates a method 300 for using QR codes to upload to and/or access and view content through a network in a database that is hosted on a server. In accordance with some implementations of the method 300, at 302, a server is hosted on a cloud computing service that provides an accessible IP address. Preferably, the IP address is accessible publicly and globally. The cloud computing service has a DNS server that can resolve the fully qualified domain name to IP addresses for hosted web services. At 304, the target website URL contains an ID parameter that is the unique 22 alphanumeric character string (“text”). The database is a table of structured data that can be read/written to via APIs defined by the cloud computing service, and the web service queries the database with the ID found in the query parameter.

At 306, the web service checks the database for a previously created folder with a name that matches the URL query parameter ID. A database ID column guarantees there can only be one folder with a given name. If the database returned no results for a folder with the name that matches the URL ID query parameter at 306, at 308 the web server sends a webpage to the browser to render a button or other user-selectable graphical feature that allows the user to upload their content to a newly-created folder. At 310, the webpage is re-rendered to show a confirmation and uploading indicator while the content is being processed. Finally, at 312, uploaded video content is converted into a universal format that can be rendered on desktop and mobile browsers. A sample row in the database for the uploaded content can have the following fields: id, name, group name, last modified timestamp, and pointer to the binary large object (BLOB). The pointer allows the database to retrieve the binary content when asked by the web service. It can be a path to the file in the database's underlying file system.

If the database returns results for a folder with the name that matches the URL ID query parameter at 306, at 314, the web server queries the database for all rows that contain the URL ID parameter as the group name. The pointers to the raw BLOB data are served as authenticated download URLs. At 316, the web server generates a webpage that contain HTML elements that renders content downloaded from an HTTP request. This webpage is served to the browser for rendering. The browser requests additional HTTP requests for each downloadable BLOB resource. The content can be rendered in the browser once download is complete. Finally, at 318, the browser receives HTTP response from web service and renders the HTML, elements, to stream, display or render the content on the user device to the user.

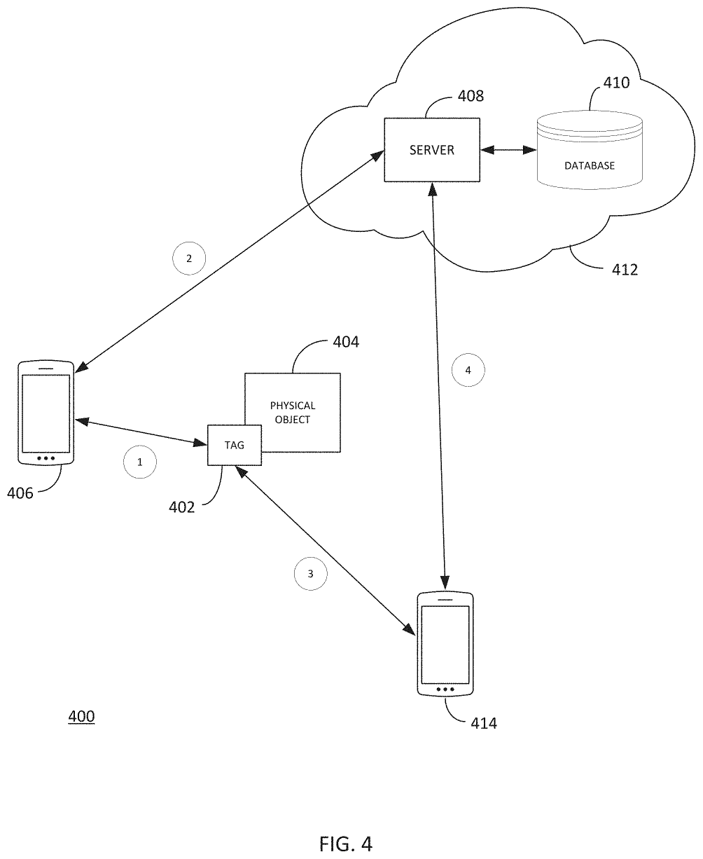

FIG. 4 depicts a system 400 that utilizes a tag 402 that is associated with a physical object 404, where the tag 402 includes, embeds, or otherwise stores a code that is readable by a smartphone that is equipped and configured with code reading technology. For instance, the tag 402 can be a NFC tag which, when in close proximity to a smartphone or other reading device, can communicate the code to the smartphone or other reading device. In some implementations, the NFC tag can be written to by the smartphone or other device, such that the code can be changed and/or augmented with additional information, such as a timestamp, user ID, a media file ID, or other information. In other instances, the tag 402 can be an RFID tag that can store the code, and which code can be read by the smartphone or other device using a reading application or similar technology.

In some implementations, a first smartphone 406 reads the code from the tag 402 associated with the physical object 404. The tag 402 can be a sticker, a tab, an encased circuit, or other low-profile physical tag that can be attached, affixed, connected or otherwise associated with the physical object 404. The physical object 404 can be any physical object, such as a card (such as a greeting card or payment card), keys, picture, poster, accessory (such as a watch, bracelet, necklace, etc.), a box or other packaging, or any other physical object.

In accordance with some exemplary implementations, the first smartphone reads the code from the tag 402 at (1) as shown in FIG. 4. Upon the reading of the code, the first smartphone can launch a media generation application. In some implementations, the media generation application is already launched, and the technology to read the code from the tag 402 is integrated with the media generation application, while in other implementations the reading technology and the media generation application are separate.

The media generation application allows a user of the first smartphone 406 to create or generate a media file, which is associated with the code provided by the tag 402. The first smartphone 406, either by the media generation application or a separate application, can the upload at (2) the media file associated with the code to a server 408 via a network 412, where it can be stored on a database 410 associated with the server 408, and where such storage includes the code associated with the tag 402. The server 408 can be a cloud server, and the network 412 can be a cloud communication network, a wireless communication network, or any other communication or data transmission network. Those with skill in the art would recognize, however, that the media file can be stored in a cloud storage facility using a serverless architecture, which is easier to scale for massive data storage and access.

The media file can thereafter be accessible from the database 410 and downloadable from the server 408 via the network 408 by a second smartphone 414 that reads the code from the same tag 402 at (3), (which may still be connected with or associated with the physical object 404), and which transmits a request to the server 408 for the media file. The request can be associated with the second smartphone 414 reading the code that is associated with the physical object 404. Once downloaded at (4), the media file is playable by the second smartphone 414. In some implementations, the second smartphone includes its own instance of the media generation application to be able to play the media file.

In some implementations, the second smartphone 414 can write additional data back to the tag 402, and which can be associated with the code and subsequently accessed by other smartphones that read the code. The additional data can also be uploaded to the server 408 for storage on the database 410 or local memory in the server 408. The additional data can include, without limitation, metadata, a blockchain, text data, image data or other data.

In some implementations, a computer program product, such as described herein (a local or distributed application, server applications, and the like), can include an augmented reality (AR) module to present a digital dimension to the physical object associated with the code. For instance, upon reading or sensing the code by a smartphone, the AR module can provide a unique experience to a user of the smartphone, such as a surprise, and advertisement related to the physical object or other physical object, or the like. The AR module can also be executed when a subsequent smartphone accesses a media file that is generated by a first smartphone.

In the case of the media file including video, the video can include buttons or other controls embedded in the video file, and which can allow a user to control the playing of the video, and/or providing feedback that is stored back in the database with the video. Accordingly, further subsequent accesses of the video can include all or some of the additional video provided by previous smartphone users.

In yet other implementations, upon reading the code by each second smartphone, the code, in addition to accessing the media file from the database, can launch any number or types of applications on the second smartphone, or even on other smartphones connected with the second smartphone, such as via a “friends” list or other social graph or network. These applications can be connected with one or more online commerce platforms, and can include an application programming interface (API) to these online commerce platforms. The online commerce platforms can include a shopping platform that lists goods and services for being bought online, or can include a review site where a user of the second or subsequent smartphones can provide a review of a product or service, which may or may not be related to the physical object that is associated with a code, such as implemented in a QR code or a tag or the like.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
reading, by a first smartphone, a code that is associated with a physical object, the code being configured to launch a media generation application on the first smartphone;
generating, by the first smartphone, a media file using the media generation application;
transmitting, by the first smartphone, the media file to a server via a network on a first communication channel for storing the media file in a database associated with the server, the storing including storing the code associated with the physical object and associating the code with the media file; and
enabling access from the database via the server to the media file by a second smartphone, the access being enabled on a second communication channel upon the second smartphone reading the code that is associated with the physical object.

2. The method in accordance with claim 1, wherein the enabling further comprises using the media generation application on the second smartphone.

3. The method in accordance with claim 1, wherein the code is defined in a quick response (QR) code that is readable by the first and second smartphones.

4. The method in accordance with claim 3, wherein the QR code is printed and affixed to the physical object.

5. The method in accordance with claim 1, wherein the code is embedded in a tag that is attached to the physical object.

6. The method in accordance with claim 5, wherein the tag is one of a near field communication (NFC) tag and a radio frequency identifier (RFID) tag that is readable by the first and second smartphones.

7. The method in accordance with claim 1, wherein the media file is a video file captured by the first smartphone, and wherein the video file is playable by the second smartphone.

8. A system comprising:
a code that is associated with a physical object, the code being configured to be read by a first smartphone
a media generation application configured to allow the first smartphone to generate a media file after reading the code, the media file being associated with the code;
a server that is configured to communicate with the first smartphone via a network for receiving the media file from the first smartphone; and
a database associated with the server and configured to store the media file based on the code,
the media file being accessible from the database and downloadable from the server via the network by a second smartphone that reads the code and transmits a request to the server for the media file, the request being associated with the second smartphone reading the code that is associated with the physical object, the media file being playable by the second smartphone after the media file is downloaded.

9. The system in accordance with claim 8, wherein the second smartphone plays the media file using the media generation application.

10. The system in accordance with claim 9, wherein the media generation application is launched on the second smartphone upon the second smartphone reading the code that is associated with the physical object.

11. The system in accordance with claim 8, wherein the code is defined in a quick response (QR) code that is readable by the first and second smartphones.

12. The system in accordance with claim 11, wherein the QR code is printed and affixed to the physical object.

13. The system in accordance with claim 8, wherein the code is embedded in a tag that is attached to the physical object.

14. The system in accordance with claim 13, wherein the tag is one of a near field communication (NFC) tag and a radio frequency identifier (RFID) tag that is readable by the first and second smartphones.

15. The system in accordance with claim 8, wherein the media file is a video file captured by the first smartphone.

16. A computer program product comprising a non-transitory machine-readable medium storing instructions that, when executed by two or more programmable processors, cause the two or more programmable processors to perform operations comprising:
read, by a first smartphone, a code that is associated with a physical object;
launch a media generation application on the first smartphone based on the read code;
generate, by the first smartphone, a media file using the media generation application;
transmit, by the first smartphone, the media file to a server via a network on a first communication channel for storing the media file in a database associated with the server, the storing including storing the code associated with the physical object and associating the code with the media file;
read, by a second smartphone, the code that is associated with the physical object;
launch the media generation application on the second smartphone based on the read code; and
access, by the second smartphone from the database via the server, the media file, the access being enabled on a second communication channel upon the second smartphone reading the code that is associated with the physical object.

17. The computer program product in accordance with claim 16, wherein the operations further comprise:
playing, by the second smartphone using the media generation application, the media file.
